(19) United States
(12) Patent Application Publication
(10) Pub. No.: US 2006/0172682 A1
(43) Pub. Date: Aug. 3, 2006

(54) Space saving vertically oriented fan

(75) Inventors: Paul W. Orr, Coatsville, PA (US); Thomas J. Dooley, Springfield, PA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Lasko Holdings, Inc., Wilmington, DE (US)

(21) Appl. No.: 11/326,878

(22) Filed: Jan. 6, 2006

Related U.S. Application Data
(60) Provisional application No. 60/641,804, filed on Jan. 6, 2005.

(51) Int. Cl. B60H 1/34

(52) U.S. Cl. 454/152

(57) ABSTRACT

A space saving fan with a minimized planar area footprint to promote space saving characteristics is provided. The device includes a cross-flow air impeller disposed within a housing. The cross-flow air impeller produces an exhaust air flow exiting the housing through an air outlet. Features of the space saving fan enhance usability on a desk and/or table top.

### CROSS REFERENCE TO RELATED APPLICATION

This application claims priority to provisional patent application 60/641,804 filed Jan. 6, 2005.

### TECHNOLOGY FIELD

The present invention relates to fans. More specifically, the present invention relates to a space saving fan used in a work area.

### BACKGROUND

Air movement in a work area, such as an office environment has been addressed for many years by conventional fans. Most conventional fans of this type are small, helping to minimize the space need for the device on a work surface such as a desk, table or counter. Although conventional fans have served this area of need they have several disadvantages.

One disadvantage of conventional devices using axial fan blades is that they often require a width that tends to impair the ability to see the area around the device. In addition, the required width makes these devices more susceptible to accidental contact and tip-over. Accidental tip over of the conventional fan can cause time and work loss. Although small in size, a conventional fan using an axial fan blade often needs a large base for stabilization, requiring the user to sacrifice a significant portion of the work surface. This space might be otherwise utilized if the conventional fan where not present.

Another disadvantage of conventional devices using axial fan blades used primarily on a table or desk top is the shape of the air pattern produced. A conventional device that uses an axial fan blade creates an air stream that is conical and increases in diameter as the distance traveled by the air stream increases. As the diameter of the air stream increases the air stream will begin to disturb object on the desk or table top. As a result, loose objects, such as paper, may be moved as the air stream passes. This may not be desirable as these objects can be dislodged from their intended place. Furthermore dust, pollen or dander on a mounting surface within the air stream will be disturbed to airborne. These dust and debris can be detrimental to, for example, respiratory conditions.

Yet another disadvantage of conventional devices using axial fan blades is the movement and distraction associated with the rotation of with an axial fan blade. This is especially detrimental if the user is located near the device, for example, when the device is used primarily on a table or desk top.

### SUMMARY

The present invention is directed to a space saving fan using a cross-flow air impeller and having an elongated vertical air outlet. The space saving fan has a minimized planar footprint area dimension enhancing its space saving characteristics.

The space saving fan as described also minimizes possible accidental tip-over and the work loss associated with such accidents. The use of a cross-flow air impeller disposed within a housing reduces the visible detectable movement of the impeller and thus reduces the distraction associated with the rotation of the impeller.

The space saving fan also has the ability to allow a user to direct the air stream where desired. The use of rotation and/or oscillation optimize the exhaust air flow directional capabilities.

As described, the space saving fan generates an air stream of sufficient velocity and volume to effectively impinge and cool the user. The effective cooling is generated by the space saving fan while occupying a minimal space on a work area, for example, a desk or table top.

Preferably, the space saving fan would be fully assembled and due to it's structure, shape and compact size it will use a shipping package that will promote efficient transportation. Transportation of the device is enhanced by greater quantities of the space saving fan being place in a shipping container, (truck). These shipping advantages serve to reduce the cost for the user.

### BRIEF DESCRIPTION OF THE DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following Figures:

FIG. 1 is a perspective view of an exemplary embodiment of a space saving fan;

FIG. 2 shows an exploded view of the exemplary embodiment of FIG. 1;

FIGS. 3A and 3B are comparative horizontal cross sections through the embodiment of FIG. 1 showing several exemplary air impeller that can be used with the space saving fan;

FIG. 4 shows dimensional aspects of various components of an embodiment of the space saving fan;

FIG. 5 shows a chart illustrating performance characteristics of an embodiment of the space saving fan;

FIGS. 6A and 6B are side and top views, respectively, of an exemplary embodiment of the space saving fan showing exhaust air flow patterns generated by the device;

FIGS. 7A and 7B show the dimensional and packaging characteristics of the space saving fan;

FIG. 8 shows another embodiment of the space saving fan; and

FIG. 9 shows another embodiment of the space saving fan.

### DETAILED DESCRIPTION OF ILLUSTRATIVE EMBODIMENTS

The following is a description of an exemplary space saving fan. As described, the space saving fan uses a cross-flow air impeller within a housing. The use of a cross-flow air impeller within reduces the detectable movement of the impeller thus reducing the distraction associated with the rotation of a conventional fan with an axial fan blade.

The housing of the space saving fan has a minimized planar footprint area dimension enhancing its saving characteristics. In one exemplary embodiment the planar usage area is less than the area of one fourth of a standard letter sized paper, or less than about 23 square inches. A conventional desk fan using a 6 inch diameter axial fan blade occupies about 35 inches square. As described, the minimized planar footprint area along with a minimized width also mitigates possible accidental tip-over and the work loss associated with such incidents.

The air stream generated by the space saving fan preferably has the proper velocity characteristics to ensure effective cooling of the user when the space saving fan is located on a desk or table. For example, it is preferred that the velocity of the air stream generated by the space saving fan be about 500 feet per minute or greater when exiting the space saving fan. This exit velocity will effectively cool the user when the space saving fan is located on a desk or table.

The space saving fan also allows a user to direct the air stream exiting through an elongate vertical outlet to a desired location. The use of rotation and/or oscillation contribute to the optimization the directional capabilities of exhaust air flow.

The compact shape and size of the space saving fan will use a shipping package promoting efficient transportation.. Greater quantities of the space saving fan can be place in a shipping container, (truck). This is an advantage to the user, serving to reduce cost.

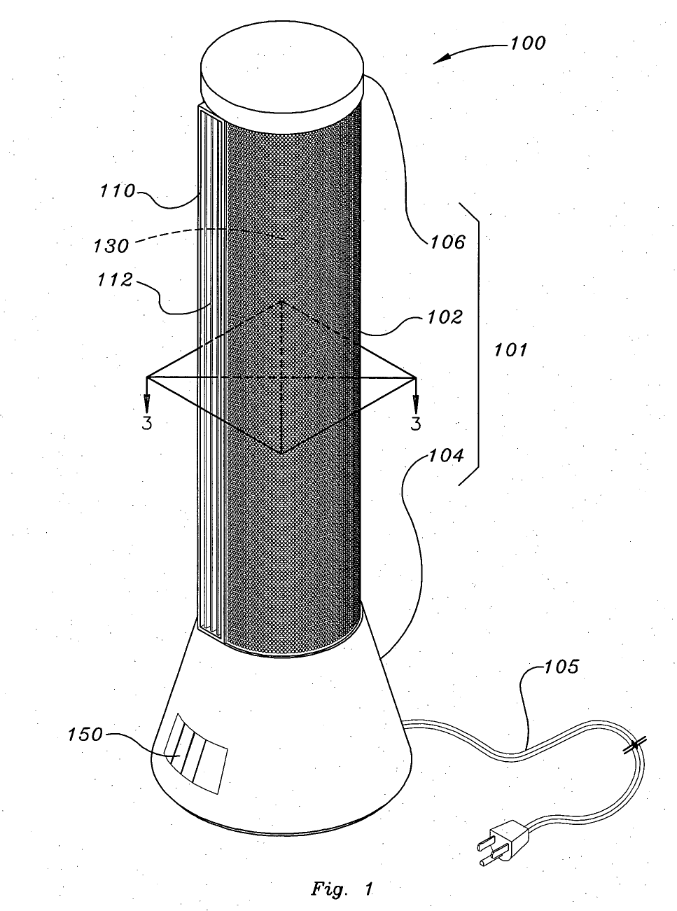

FIG. 1 is a perspective view of an exemplary space saving fan 100. As shown in FIG. 1, space saving fan 100 includes elongated housing 101. Elongated housing 101 includes side wall 102, bottom portion 104 and top portion 106. In this example, side wall 102 is fabricated of perforated material. Vertical air outlet 110 is shown in elongated housing 101. Vertical air outlet 110 may include grill elements 112 for directing a flow of exhaust air exiting vertical air outlet 110.

Impeller assembly 130 is disposed within elongated housing 101. Impeller assembly 130 induces intake air to enter elongated housing 101. Impeller assembly 130 accelerates the intake air creating an exhaust air flow which exits elongated housing 101 via vertical air outlet 110.

As shown, space saving fan 100 also includes at least one control assembly 150. Control assembly 150 controls one or more functions of space saving fan 100. Also shown is power cord 105, utilized to connect space saving fan 100 to an electrical power source (i.e. wall outlet). The electrical component connections of space saving fan 100 are integrated within the device, such as for example between control assembly 150 and impeller assembly 130. The integration of the electrical component connections within the device eliminates the need for the user to make such connections. In the exemplary embodiment shown, for example, only the connection of power cord 105 to an electrical power source is required for operation of the device. The integration of all the electrical component connections within the device also enhance the portability of space saving fan 100.

Preferably power cord 105 will utilize a safety plug. Details of the safety plug and it's advantages are described in U.S. Pat. No. 6,394,848 No. 6,604,965 No. 6,793,535 and No. 6,896,544, each of which are incorporated herein by reference.

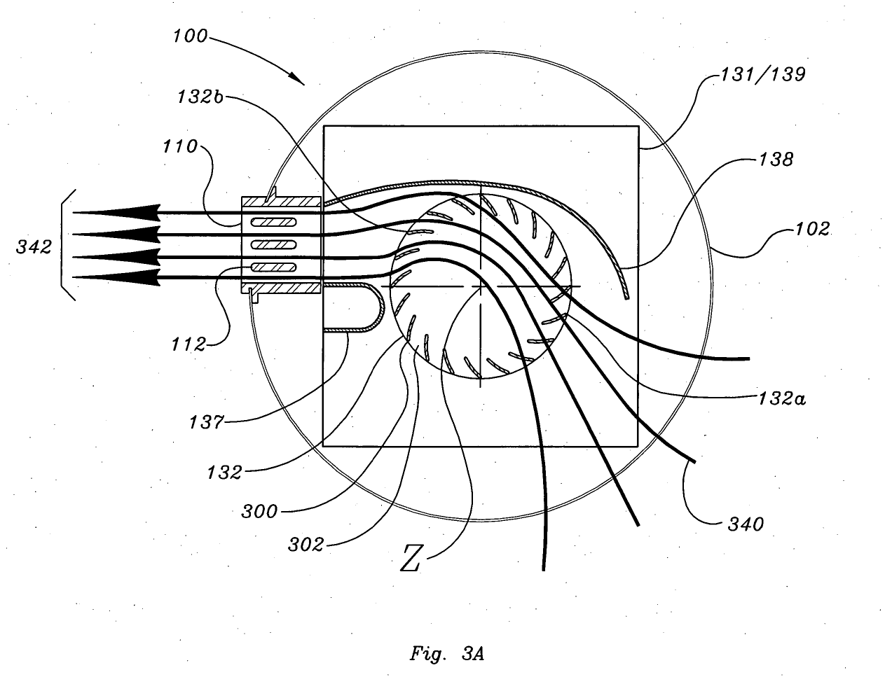

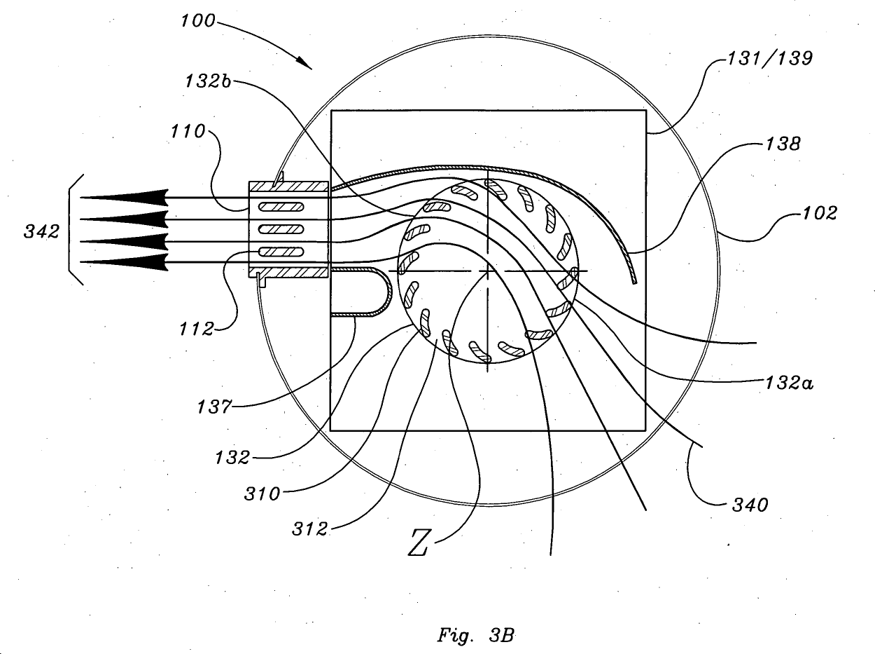

Also shown in FIG. 1 is cross section plane 3-3. The horizontal cross section taken along cross section plane 3-3 is illustrated in FIGS. 3A and 3B.

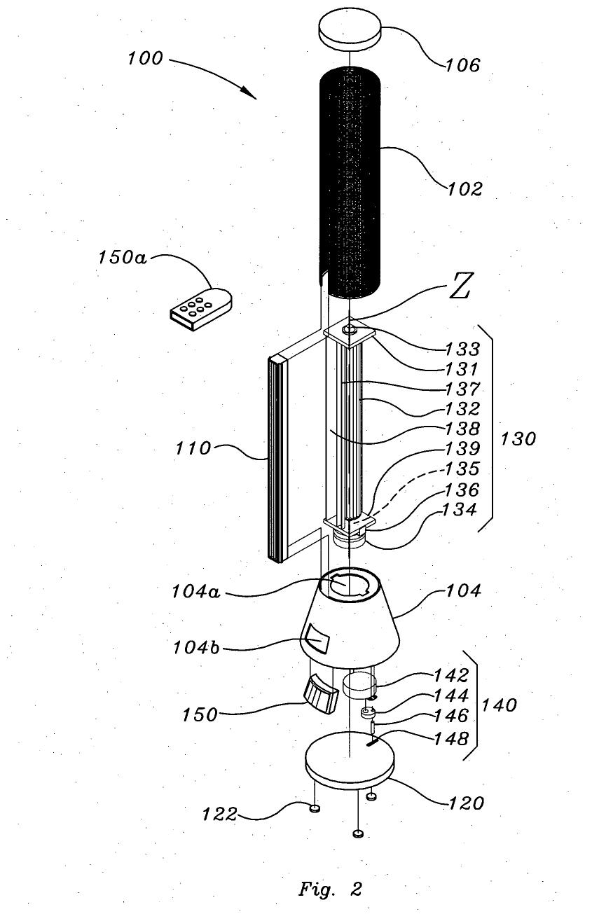

FIG. 2 is an exploded perspective view of space saving fan 100. As shown in FIG. 2, elongated housing 101 may be constructed of more than one component, such as for example, side wall 102, bottom portion 104 and top portion 106. In this example, side wall 102 is fabricated of perforated material. Vertical air outlet 110 located in this example located proximate side wall 102 and between bottom portion 104 and top portion 106 of elongated housing 101. It is contemplated that elongated housing 101 and vertical air outlet 110 may be assembled together using assembly device, (not shown), such as for example; screws, adhesives or snaps.

As shown, air outlet 110 is a separate part, however it is contemplated that air outlet 110 may be unitary with another part of space saving fan 100, for example, side wall 102, bottom portion 104, top portion 106 and/or impeller assembly 130.

Disposed within elongated housing 101 is impeller assembly 130. As shown impeller assembly 130 includes cross-flow air impeller 132 and motor 134. Cross-flow air impeller 132 is connected to motor 134 via motor shaft 135. Cross-flow air impeller 132 is supported by upper frame 131 and bearing 133 as shown. Motor 134 is connected to lower frame 139 via motor bracket 136. In this example, air cut-off 137 and air guide 138 are disposed between upper frame 131 and lower frame 139. Air cut-off 137 and air guide 138 are used to structurally support upper frame 131 and lower frame 139 relative to each other. Motor 134 rotates cross-flow air impeller 132 about axis of rotation Z. As shown in the present embodiment, axis of rotation Z has a substantially vertical orientation.

It is contemplated that portions of the impeller assembly, such as for example upper frame, 131, lower frame 139, air cut-off 137 and/or air guide 138 may be unitary in construction with other parts of space saving fan 100, such as for example side wall 102, bottom portion 104 and/or top portion 106 of elongated housing 101.

As shown in FIG. 2, cross-flow air impeller 132 has a predetermined diameter and a predetermined axial length defining a vertically elongated aspect ratio. In one embodiment the predetermined length to the predetermined diameter aspect ratio of cross-flow air impeller 132 is greater than about 2:1. In yet another embodiment the predetermined diameter of cross-flow air impeller is less than or equal to about 2.5 inches. Maintaining the elongated aspect ratio of cross-flow air impeller 132 allows impeller assembly 130 to fit within elongated housing 101 providing for the space saving characteristics of space saving fan 100.

As shown in FIG. 2, motor 134 is preferably located within bottom portion 104 of elongated housing 101 via aperture 104a. The location of motor 134 as described enhances the stability of space saving fan 100 by lowering the mass of motor 134, and hence space saving fan 100, relative to a support surface. The enhanced stability of space saving fan 100, as described, minimizes the base size required to maintain space saving fan 100 in a vertical upright position. The ability to use a minimized base enhances the space saving characteristics of space saving fan 100.

Preferably, motor 134 will be a ventilated type electric motor. A ventilated motor allows air to enter motor 134 and efficiently cool motor 134 when in use. The cooling of motor 134 will allow a reduction of materials and reduce the cost of motor 134, which in turn will reduce the overall cost of space saving fan 100. The minimized predetermined diameter of cross-flow air impeller 132 must be rotated at a sufficient speed to produce an exhaust air flow with the desired velocity characteristics (see FIG. 5). The desired velocity of the exhaust air flow should be sufficient to efficiently impinge the exhaust air flow onto the surface (skin) of the user and maximize the evaporation of moisture (sweat). Evaporation contributes to the cooling sensation experienced by the user.

It is contemplated that motor 134 of impeller assembly 130 may be an electric motor using AC current or DC current. It is also contemplated that space saving fan 100 using a DC current motor 134 may use various power sources, such as for example, batteries and the electrical systems of automobiles, boats, buses, etc. The ability to use batteries will increase the portability of space saving fan 100. It is contemplated that space saving fan 100 may be a hand held battery operated cooling device.

FIG. 2 also shows oscillating mechanism 140. Oscillating mechanism 140 moves elongated housing 101 of space saving fan 100 through a range of oscillation movement. The oscillation movement allows the flow of exhaust air to be dispersed over a larger area if desired. Oscillating mechanism 140, in this example, is comprised of oscillation motor 142, offset wheel 144, pin 146 and base slot 148. Oscillation motor in the present exemplary embodiment is fixedly connected to bottom portion 104 and bottom portion 104 is rotatably connected to base 120. Oscillation motor 142 rotates offset wheel 144 which in turn rotates pin 146. Offset wheel 144 defines a distance between the axis of rotation of oscillation motor 142 and pin 146. Pin 146 fits into base slot 148. As offset wheel 144 rotates bottom portion 104 is forced to rotate and/or oscillate relative to base 120. Base 120 is stationary relative to a support surface and the dynamic of oscillation mechanism 140 as described oscillates or rotates elongated housing 101 relative to base 120. It is contemplated that oscillation mechanism 140 could be inverted wherein oscillation motor 142 would be fixedly connected to base 120 and base slot 148 would be attached to bottom portion 104. In this case the resultant movement of elongate housing 101 is the same. It is also contemplated that other oscillating mechanisms, such as for example a link and pivot or a reversible synchronous motor and gears may be used to achieve the desired oscillation movement. Also shown in FIG. 2 are feet 122.

The space saving aspect of space saving fan 100 for use on a work surface, such as for example, a desk or table top is enhanced by a limited size and uses less space of the work surface than a conventional fan with an axial impeller. The limited space available for oscillation mechanism 140 may also limit the inclusive angular range of oscillation movement of elongated housing 101 to less than about 60 degrees. Limiting the inclusive angular range of oscillation contributes to the reduction in size of oscillation mechanism 140, thus enhancing the ability of oscillation mechanism 140 to fit within the space defined by bottom portion 104.

As shown in this example, the rotational axis of oscillation of elongated housing 101 is preferably parallel with axis of rotation Z of cross-flow air impeller 132. This reduces the effects of gyroscopic precession during the oscillation of elongated housing 101 and increases the stability of space saving fan 100. In one embodiment the rotational axis of oscillation of elongated housing 101 is substantially co-linear with axis of rotation Z of cross-flow air impeller 132.

Control assembly 150 is used to control a function of space saving fan 100, such as, for example, the rotational speed of impeller 132 and/or the rotation or oscillation of housing 101. As shown, control assembly 150 may include, for example, switches, power control boards and LED indicators. In one preferred embodiment, control assembly 150 is mounted on bottom portion 104 of housing 101 via aperture 104b. Alternatively, remote control unit 150a may accomplish the control of space saving fan 100 in conjunction with, and/or as a replacement for control assembly 150.

It is contemplated that motor 134 will be a multi speed motor. The use of multi-speed motor 134 permits the user to adjust the air quantity and air velocity of the exhaust air flow as desired. It is further contemplated that a single speed motor 134 used in conjunction with control assembly 150 may be used to vary the rotational speed of cross-flow air impeller 132, achieving similar results to those of a variable speed motor.

Space saving fan 100 may be constructed with material such as polymers, sealed motors, sealed switches and other components, such as for example rain sensors that could optimize a weather proof construction. This would facilitate the use of space saving fan 100 in areas that might be exposed to varying weather conditions.

FIGS. 3A and 3B are horizontal cross sections along plane 3-3 shown in FIG. 1. As shown in FIG. 3A, intake air 340 is drawn into space saving fan 100 through side wall 102 by a rotation of cross-flow air impeller 132. Cross-flow air impeller 132 accelerates intake air 340 creating exhaust air flow 342 which exits space saving fan 100 via vertical air outlet 110. Vertical air outlet 110 includes grill elements 112. Grill elements 112 direct and guide exhaust air flow 342 to form a substantially linear air flow as shown. The ability to form a substantially linear air flow allows exhaust air flow 342 to be more precisely directed where desired by the user of space saving fan 100.

Grill elements 112 are designed to minimize their impedance to an exhaust air flow exiting space saving fan 100 via vertical air outlet 110. The use of grill elements 112 combined with the substantially direct and unimpeded fluid communication between cross-flow air impeller 132 and vertical air outlet 110, further enhances the ability of space saving fan 100 to produce the desired velocities of exhaust air flow 342. Alternatively-grill elements 112 may be, for example, vertical slats movable in a louvered fashion allowing exhaust air flow 342 to be directed horizontally to the right and/or left. Additional horizontal louvers (not shown) may be incorporated into vertical air outlet 110 allowing exhaust air flow 342 to be directed vertically to the up and/or down.

Also shown in FIG. 3A is air cut-off 137 and air guide 138. The position of air cut-off 137 air guide 138 relative to cross-flow air impeller 132 allow the free rotation of cross-flow air impeller 132 around axis of rotation Z. Air guide 138, in this example, is concave when referenced from axis of rotation Z of cross-flow air impeller 132. Air cut-off 137, in this example, is convex when referenced from axis of rotation Z of cross-flow air impeller 132.

Air guide 138 and air cut off 137 divide cross-flow air impeller 132 into intake side 132a and exhaust side 132b. Intake side 132a is defined as a first distance measured in a direction of rotation of cross-flow air impeller 132 along it's circumference from the point of closest radial proximity between cross-flow air impeller 132 and air cut off 137 to the point of closest radial proximity between cross-flow air impeller 132 and air guide 138. Exhaust side 132b is defined as a second distance measured in a direction of rotation of cross-flow air impeller 132 along the circumference of cross-flow air impeller 132 from the point of closest radial proximity between cross-flow air impeller 132 and air guide 138 to the point of closest radial proximity between cross-flow air impeller 132 and air cut off 137. Intake side 132a of cross-flow air impeller 132 is in direct fluid communication with side wall 102. In a like manner exhaust side 132b of cross-flow air impeller 132 is in a direct and substantially unimpeded fluid communication with vertical air outlet 110.

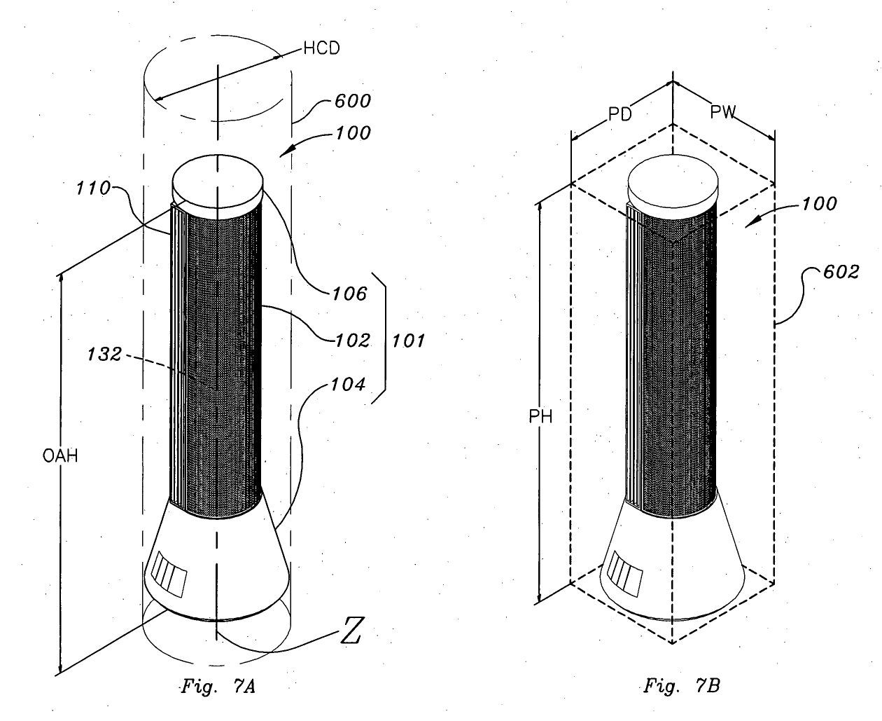

As shown in FIG. 3A, vertical air outlet 110 is located off-center to side wall 102 of space saving fan 100. The off-center or asymmetrical location of vertical air outlet 110 relative to side wall 102 enhances the efficient flow of intake air 340 into space saving fan 100 and the efficient flow of exhaust air flow 342 out of space saving fan 100. Maintaining the optimum air flow characteristics of cross-flow air impeller 132 within the limited space of side wall 102, (see FIG. 7A) is made possible by the off-center or asymmetrical location of vertical air outlet 110 relative to side wall 102. As shown, the majority of intake air 340 enters side wall 102 in a quadrant substantially diagonal to the quadrant from which exhaust air flow 342 exits side wall 102. In addition, the offset design further provides a more direct and substantially unimpeded flow of the exhaust air flow 342 as it flows from the air impeller 132 and out the air outlet 110.

As shown in FIG. 3A cross-flow air impeller 132 is constructed of a plurality of blades 300 defining air channels 302 located between blades 300. Blades 300 and air channels 302 are located proximate the circumference of cross-flow air impeller 132. FIG. 3A is illustrative of a cross-flow air impeller fabricated of metal.

FIG. 3B is similar to FIG. 3A except that cross-flow air impeller 132 is fabricated of polymer. Because of the molding constraints of polymer materials, such as for example draft requirements and plastic flow properties the thickness of blades 310 are about 3 times greater when compared to the thickness of metal blades 300 of FIG. 3A. The size of air channels 312 must be sufficient to allow intake air 340 to effectively flow through cross-flow air impeller 132. The additional thickness of blades 310 along with a sufficient size of air channels 312 limit the number of blades 310 located proximate the circumference of cross-flow air impeller 132 as compared to metal blades (see FIG. 3A). The number of blades located proximate the circumference of a cross-flow air impeller influences the volume of exhaust air flow 342. The greater the number of blades accompanied by properly sized air channels increases the volume of exhaust air flow 342.

As can be appreciated by comparing FIG. 3A to FIG. 3B the number of blades 300 on cross-flow air impeller 132 fabricated of metal (FIG. 3A) is greater than the number of blades 310 on cross-flow air impeller 132 fabricated of polymer (FIG. 3B). For example, cross-flow air impeller 132 having a pre-determined diameter of about 1.2 inches would utilize about 20 metal blades 300 with a blade material thickness of about 0.016 inches. For a similar cross-flow impeller 132 having a pre-determined diameter of about 1.2 inches using polymer blades 310 with a blade material thickness of about 0.045 inches the number of blades would be about 16. In a preferred embodiment, cross-flow air impeller 132 has a pre-determined diameter less than or equal to about 2.5 inches with about 18 to 22 metal blades 300 having a blade material thickness between about 0.01 inches and 0.02 inches.

The ability to form blade 300 from thin metal compared to a thick polymer blade 310 allows cross-flow air impeller 132 of FIG. 3A to produce exhaust air flow 342 having a sufficient volume of air. In a preferred embodiment, blades 300 of cross-flow air impeller 132 are formed of metal. It is contemplated that thin molded polymer blades may be utilized if formed of high melt flow polymer. Separate polymer parts, for example, cut and formed from thin polymer sheet stock could also be used to fabricate a thin polymer blade. However these polymer applications may increase the cost associated with the production of cross-flow air impeller 132.

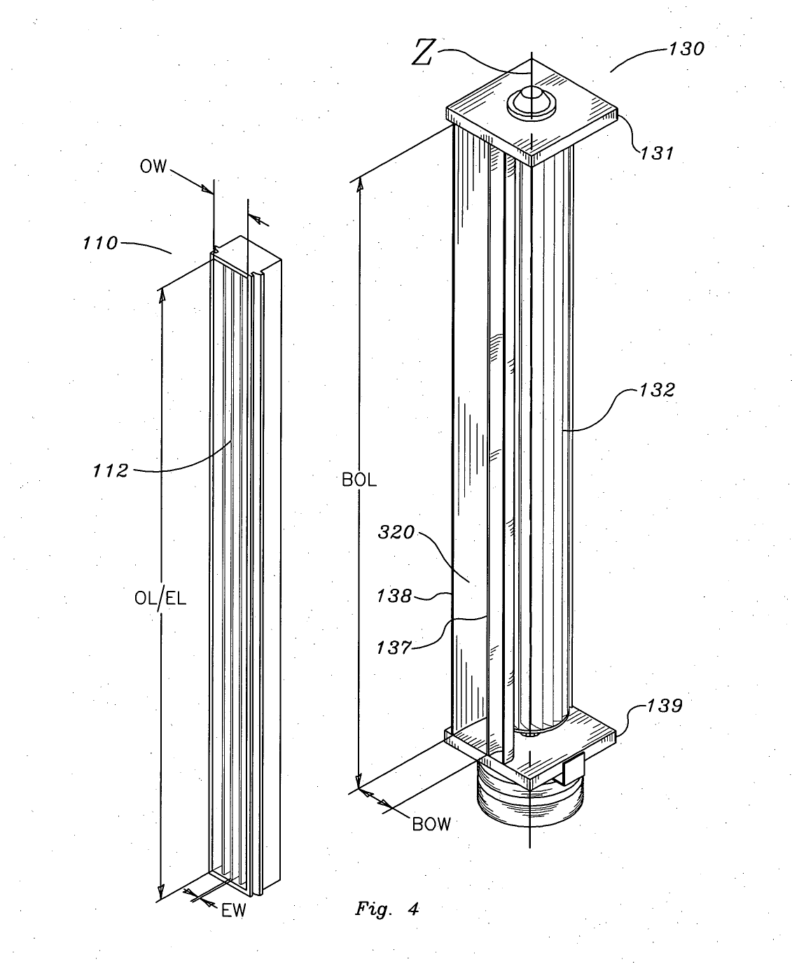

FIG. 4 illustrates exemplary proportions of vertical air outlet 110 compared to exhaust port 320 of impeller assembly 130. The flow through area “AB” of exhaust port 320 of impeller assembly 130 is defined as the width of exhaust port 320 dimension “BOW” multiplied by the vertical length dimension “BOL” of exhaust port 320. “BOW” is defined as the minimum dimension from cut-off 137 to air guide 138. “BOL” is defined as the maximum vertical extents of exhaust port 320, in this example “BOL” is shown as the minimum distance between upper frame 131 and lower frame 139. In another embodiment “BOL” is substantially equal to the vertical length of cross-flow air impeller 132. The flow through area “AO” of vertical air outlet 110 is defined as width “OW” multiplied by the vertical length “OL” of vertical air outlet 110 minus the area of all grill elements 112. Outlet width “OW” is defined as the dimension that includes the maximum horizontal extents of the opening of vertical air outlet 110 measured parallel to a mounting surface. Vertical length “OL” is defined as the length that includes the vertical extents of the opening of vertical air outlet 110 measured perpendicular to a mounting surface. The area of all grill elements 112 in the exemplary embodiment is defined as the element width “EW” multiplied by the element length “EL” multiplied by the number “n” of grill elements.
AB of exhaust port 320=BOW×BOL
AO of vertical air outlet 110=(OW×OL)−(EW×EL×n)

In the embodiment, shown grill elements 112 are straight, vertical and extend the length of dimension “OL”, however the invention is not so limited. It is contemplated that other structures for grill elements 112 may be used such as, for example: holes (substantially circular and/or substantially polygonal), diagonal elements and horizontal elements, or a combination of vertical, horizontal, diagonal elements. The actual area of all grill elements 112 should be calculated based on their actual forms and dimensions.

The flow through area “AO” of vertical air outlet 110 is dimensioned and configured to minimize it's impedance to exhaust air flow 342 (see FIG. 3A) and enhance the ability of exhaust air flow 342 to maintain it's velocity and be directed as desired as it exits space saving fan 100. In one embodiment the flow through area “AO” of vertical air outlet 110 is greater than about 50% of flow through area “AB” of exhaust port 320. This proportion enhances the ability of exhaust air flow 342 to exit from space saving fan 100 with minimal flow impedance.
AO>0.5×AB

As shown vertical air outlet 110 has a vertical aspect ratio defined by “OL” being greater than “OW”. In one exemplary embodiment the vertical aspect ratio of vertical air outlet 110 is greater than about 4:1. More preferably, the vertical aspect ratio of greater than about 6:1. In one exemplary embodiment width “OW” of vertical air outlet 110 is less than about 1.5 inches and length “OL” of vertical air outlet 110 is greater than about 6 inches.

As described, vertical air outlet 110 and grill elements 112 and the ability to direct exhaust air flow 342 has advantages when compared to a conventional axial blade fan. A conventional fan using an axial fan blade creates an air stream that is conical in shape that increases in diameter as the distance traveled by the air stream increases. As the diameter of the air stream increases the air stream disturbs object on the desk or table top. As a result, loose objects, such as paper, may be moved as the air stream passes. This may not be desirable as these objects can be dislodged from their intended place. Furthermore dust, pollen or dander on a mounting surface within the air stream will be disturbed to airborne. These dust and debris can be detrimental to, for example, respiratory conditions. As described, vertical air outlet 110 and grill elements 112 maintain a columnar shaped vertically oriented exhaust air flow minimizing the problems described regarding a conventional fan. Grill elements 112 ideally will enhance the laminar flow of exhaust air flow 342 further increasing the ability to direct exhaust air flow 342 as desired. The columnar shaped, vertically oriented exhaust air flow also conforms more closely to the human form.

FIG. 5 is a chart illustrating the effect of the rotational speed of cross-flow air impeller 132 on the velocity and volume of exhaust air flow 342. Cross-flow air impeller 132 utilized to generate the data used on the chart of FIG. 5 has a diameter of about 1.2 inches, a total of about 20 metal blades 300 located proximate the circumference of cross-flow air impeller 132 and an axial length of about 11.5 inches. The maximum velocity of exhaust air flow 342 for a specific RPM of impeller 132 is measured by locating an anemometer proximate vertical air outlet 110 of portable space saving fan 100. The anemometer is moved vertically up and down and horizontally until maximum velocity within exhaust air flow 342 is located. The air volume in cubic feet per minute (CFM) of exhaust air flow 342 for a specific RPM of cross-flow impeller 132 is calculated using an average velocity of air flow 342 at air outlet 110.

In one embodiment the maximum velocity of exhaust air flow 342 measured proximate vertical air outlet 110 of portable space saving fan 100 is about 500 feet per minute or greater and the maximum air volume of exhaust air flow 342 is about 20 CFM or greater. As described exhaust air flow 342 has velocity characteristics suitable to effect the cooling of a user when the space saving fan is located on a desk.

In a preferred embodiment cross-flow air impeller 132 has a rotational speed of about 1850 RPM or greater. In one embodiment motor 134 of impeller assembly 130 (see FIG. 2) is a two pole motor. The rotational speed of air impeller 132 as described allows cross-flow impeller 132 having a limited pre-determined diameter of less than or equal to about 2.5 inches to produce the desired air velocities.

In a preferred embodiment, cross-flow air impeller 132 has a pre-determined diameter of less than or equal to about 2.5 inches with about 18 to 22 metal blades 300 and is rotated between 2000 and 3500 RPM. As described, the preferred maximum velocity of exhaust air flow 342 measured proximate vertical air outlet 110 of portable space saving fan 100 is greater than about 1000 feet per minute and the air volume of exhaust air flow 342 is greater than about 35 CFM.

The electromagnetic field (EMF) generated by motor 134 will have adverse effects on other electrical devices within close proximity. This is particularly detrimental if portable space saving fan 100 is designed for desk-top use.

The use of a C-frame two pole shaded pole motor may effect a computer monitor if located close to space saving fan 100. Ideally all of the magnetic flux generated by the coil of an electric motor is contained within the ferrous materials of the motor. The C-frame two pole shaded pole motor design attempts to force all of the generated magnetic flux to travel in one direction. This unidirectional flux path is not normal and allows a portion of the generated magnetic flux to travel through the air, increasing the size of the EMF around the C-frame two pole shaded pole motor. This enlarged EMF interferes with other electrical apparatus in close proximity. The use of an EMF shield, (not shown) could be utilized to mitigate these adverse effects of a C-frame motor.

The use of a 2 pole shaded pole motor with separate direct wound coils, as opposed to the C-frame design greatly reduces the size of the generated EMF and it's effect on other electrical devices located close to space saving fan 100. The direct wound motor has ferrous material available in both directions from the north to the south poles of the coil and thus contains stray magnetic flux within the motor, reducing flux lines in the air around the motor. This greatly reduces the size of the EMF field and enhances the desktop use of portable space saving fan 100.

In a preferred embodiment motor 134 is a 2 pole shaded pole motor with separate direct wound coils. In another embodiment motor 134 has an EMF shield, (not shown). The use of direct wound coils and/or an EMF shield enhances the use of space saving fan 100 designed for use on a desk-top. The use of a 2 pole shaded pole motor with separate direct wound coils reduces the need to use an EMF shield and contributes to a lower cost for the manufacturer and the consumer.

As described, the limited pre-determined diameter of less than about 2.5 inches for cross-flow air impeller 132 lowers the volume of air produced as exhaust air flow 342. The limited volume of air produced does not require the power that would be needed to move a greater volume of air. The lower power requirement reduces the motor torque required thereby decreasing the heat generated by the motor 134. Motor 134 can therefore utilize fewer materials decreasing it's cost while yet producing the desired air velocity and a sufficient volume for exhaust air flow 342. This in turn yields cost savings for the manufacturer and the consumer. In one embodiment motor 134 is produces a maximum torque of less than about 1.0 inch-ounce.

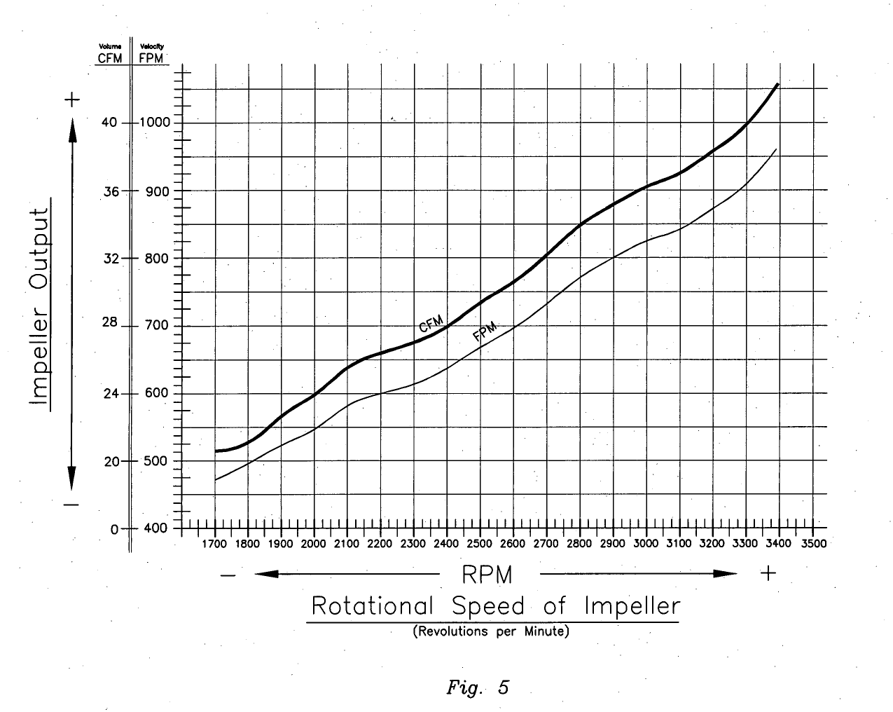

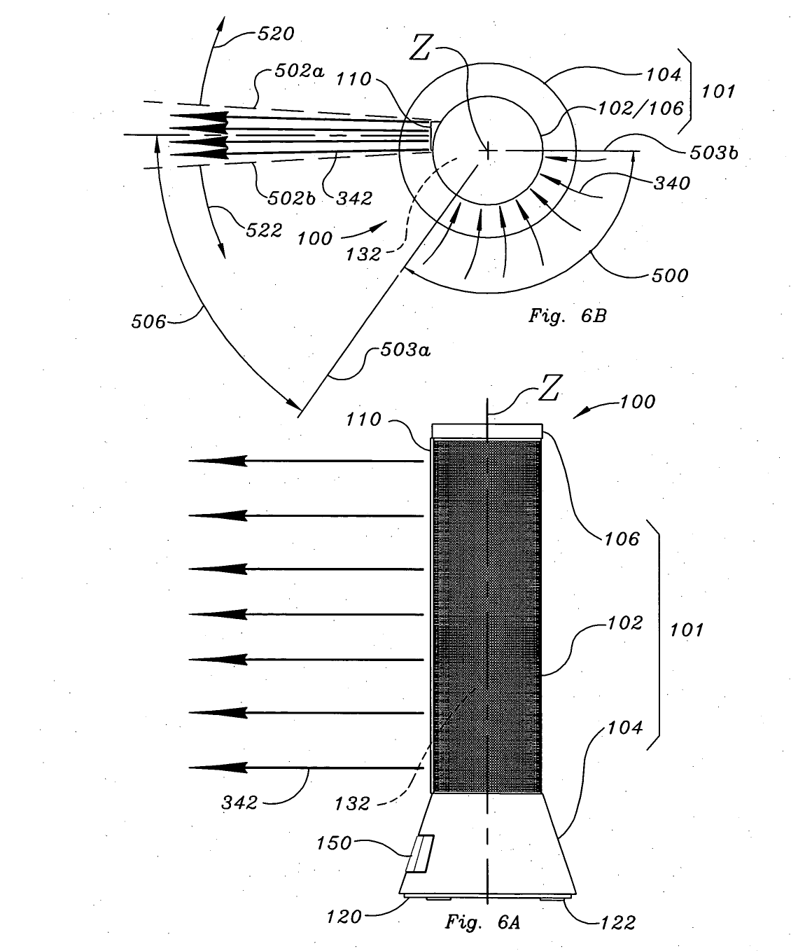

FIGS. 6A and 6B are side and top views, respectively, of an exemplary embodiment of the space saving fan 100 illustrating exemplary air flow patterns generated. As shown in FIGS. 6A and 6B, intake air 340 is drawn into housing 101 by the rotational movement of cross-flow air impeller 132. Cross-flow air impeller 132 imparts energy to the flow of air and generates exhausts air flow 342. As shown in FIGS. 6A and 6B, exhaust air flow 342 exits from housing 101 via vertical air outlet 110.

Referring to FIG. 6B, exhaust air flow 342 exits housing 101 in a linear fashion along exhaust flow path center line 504 and substantially within focused air stream boundaries 502a and 502b. The oscillation or rotation of housing 101 could be incorporated to allow exhaust air flow 342 to be re-directed horizontally along arrows 520 and 522.

As shown in FIG. 6B, substantially all of intake air 340 is drawn into housing 101 within an area designated by angle of intake 500. Angle of intake 500 has its vertex located proximate axis of rotation Z of cross-flow air impeller 132 and is defined by intake air boundaries 503a and 503b. Intake air boundaries 503a and 503b are defined by radial lines projecting from the vertex of angle of intake 500 through the extents of intake air 340 as it enters housing 101. As shown, angle of intake 500 is located relative to exhaust flow path center line 504 by angle 506.

In one embodiment, angle of intake 500, defined by intake air boundaries 503a and 503b is greater than about 60 degrees. In another embodiment, angle of intake 500 defined by intake air boundaries 503a and 503b is between about 70 degrees and about 135 degrees. Preferably, side wall 102 of housing 101 permits intake air 340 to be drawn into housing 101 between intake air boundaries 503a and 503b that allows angle of intake 500 to be relatively large, thereby helping to increase the efficiency of cross-flow air impeller 132. Angle 506 is defined as the angle between exhaust flow path center line 504 and the closer of either of intake air boundary 503a or intake air boundary 503b. In one embodiment, angle 506 is greater than about 45 degrees. Maintaining angle 506 greater than 45 degrees reduces the air recirculation that can occur between exhaust air flow 342 and intake air 340.

Similar to FIG. 3A, FIG. 6B shows vertical air outlet 110 located off-center to side wall 102 of space saving fan 100. The angle of intake 500 of intake air 340 is located in a quadrant substantially diagonal to the quadrant from which exhaust air flow 342 exits side wall 102 via vertical air outlet 110.

One manner to assure that intake air boundaries 503a and 503b define a large angle of intake 500 is to construct a substantial portion of side wall 102 of housing 101 of porous material. Porous materials, such as for example, perforated metal, expanded metal and porous polymer allow angle of intake 500 to assume it's largest and most naturally efficient size.

Although side wall 102 has been shown as a substantially porous material, such as, for example, perforated metal, the invention is not so limited. It is contemplated that side wall 102 could be constructed from a substantially non-porous material, having air inlet openings, (not shown) in the area designated by angle of intake 500. The use of a substantially non-porous material as side wall 102 conceals cross-flow air impeller 132 within the structure of the housing 101. Concealing cross-flow air impeller 132 within housing 101 reduces the distraction experienced by the user due to visible rotation of cross-flow air impeller 132. The reduction of distraction experienced by the user is advantageous to a work environment when space saving fan 100 is used in close proximity to the user, for example, on a desk or table top. Another advantage of substantially concealing cross-flow air impeller 132 within the structure of the housing 101 is increased safety. This limits the possible entry points that foreign object may use to access cross-flow air impeller 132 of space saving fan 100, thereby improving the safety characteristics of space saving fan 100 when compared to conventional fans that utilize axial blades. Space saving fan 100 does not require large open grills to protect the exposed axial fan blade found on conventional fans.

FIG. 7A shows a perspective view of an exemplary embodiment of space saving fan 100 illustrating overall dimensions. Overall height “OAH” is defined as the dimension from a mounting surface to a highest vertical extent of space saving fan 100. Hypothetical cylinder diameter “HCD” is defined as a minimal diameter dimension of hypothetical cylinder 600 capable of encompassing the extents of housing 101 of space saving fan 100. The axis of hypothetical cylinder 600 is oriented substantially parallel to axis of rotation Z of cross-flow air impeller 132.

Space saving fan 100 has a vertical aspect ratio defined as “OAH” being greater than “HCD”. In one exemplary embodiment the vertical aspect ratio of space saving fan 100 is greater than about 2 to 1. Space saving fan 100 also has a planar usage area. The planar usage area is the area that space saving fan 100 occupies on a mounting surface, such as, for example, a desk or table top. The planar usage area of space saving fan 100 is defined by the area of “HCD”. In one exemplary embodiment the planar usage area is less than the area of one fourth of a standard letter sized paper, or less than about 23 square inches. In another exemplary embodiment “HCD” is limited to about 5 inches or less. In yet another exemplary embodiment “HCD” is limited to a range between about 1.5 inch and about 4.5 inches. Limiting “HCD” and the planar usage area as described minimizes the obtrusiveness of space saving fan 100 and maximizes the available usable work area on a mounting surface, such as, a desk or table top.

FIG. 7B is a perspective view of an exemplary embodiment showing overall dimensions of shipping package 602 for space saving fan 100. Shipping package 602 is defined by height “PH”, width “PW”, and depth “PD”. In one preferred embodiment, the structure of space saving fan 100 allows the device to be shipped completely assembled. In one embodiment “PH” of shipping package 602 is less than about 115% of “OAH” of space saving fan 100, “PW” of shipping package 602 is less than about 115% of “HCD” of space saving fan 100 and “PD” of shipping package 602 is less than about 115% of “HCD” of space saving fan 100. The structure of space saving fan 100 and shipping package 602 so described allows the maximum number of units to be shipped in a shipping container, thus minimizing the cost of transportation.

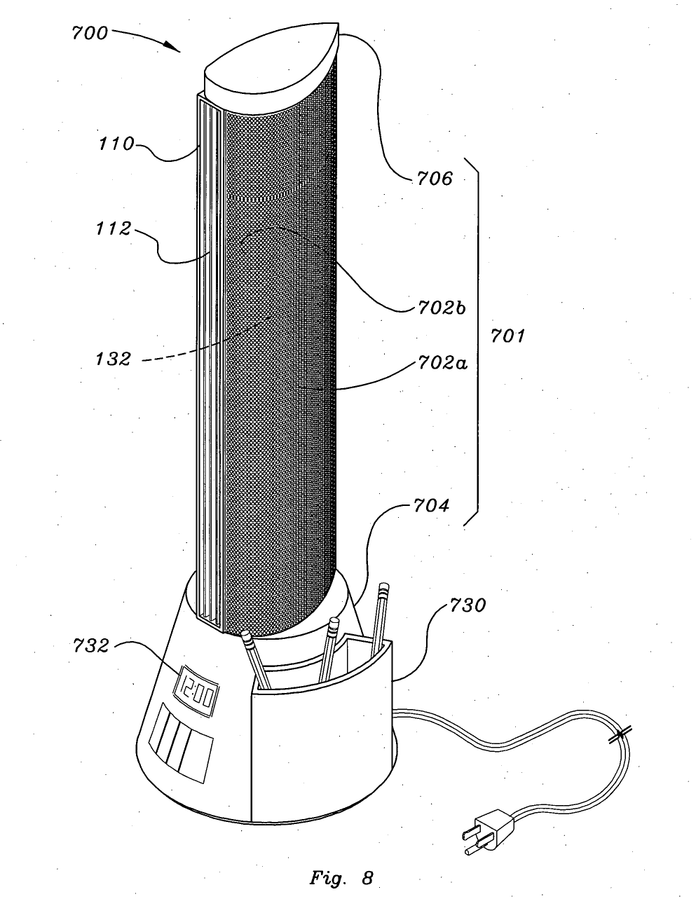

FIG. 8 is an alternative embodiment of space saving fan 700 showing various additional features. As shown space saving fan 700 may include clock 732. It is contemplated that analog clocks, thermometers and other electronic devices may be used in lieu of clock 732. Also shown is compartment 730. As shown in the present embodiment compartment 730 is located on a side of bottom portion 704 of housing 701. Compartment 730 may be used to store pencils, pens, paperclips, etc. A light source, (not shown) could be incorporated into space saving fan 700 thus allowing space saving fan 700 to also serve as a desk and/or table light. Preferably the light source would be located near top portion 706 of space saving fan 700 and be thus elevated above a mounting surface. It is also contemplated that air quality components, such as for example filters and/or ionizers could be incorporated into space saving fan 700.

FIG. 8 also shows housing 701 including side wall 702a and side wall 702b. As shown side wall 702a is constructed of a porous material, such as for example, metal or polymer. Side wall 702b may be constructed of a non-porous material. The location of side walls 702a and 702b relative to cross-flow air impeller 132 located inside housing 701 is closer than previous embodiments. It can be appreciated that the cross sectional shape of housing 701, (housing 101 of previous embodiments) can be formed in a variety of shapes such as, for example, ovals, polygons and ellipses.

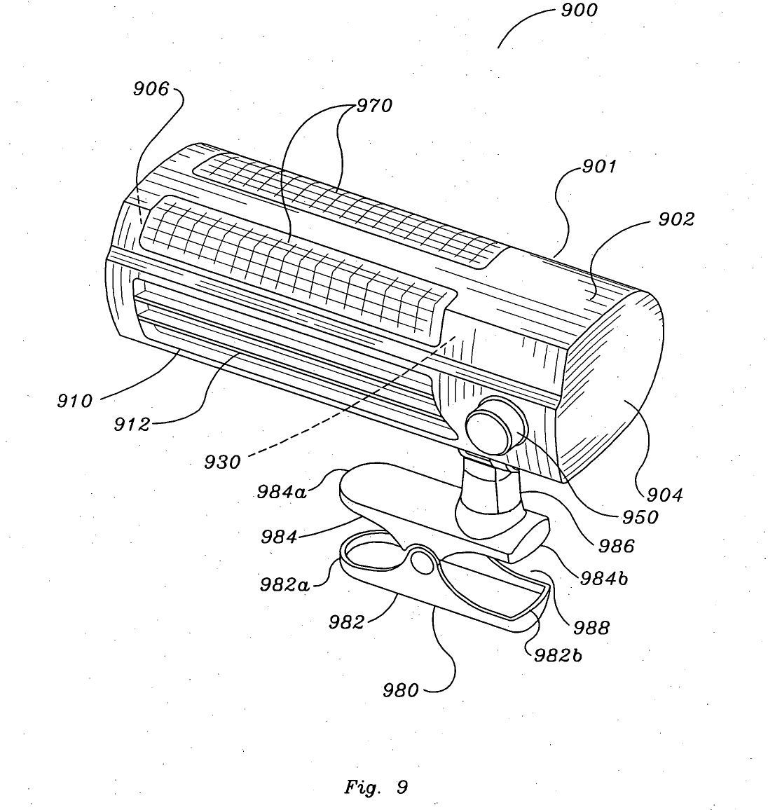

FIG. 9 is a perspective view of another alternative embodiment of space saving fan 900. As shown in FIG. 9, space saving fan 900 includes elongated housing 901 and attachment mechanism 980.

Elongated housing 901 includes side wall 902. In this example side wall 902 includes air inlets 970. Air outlet 910 is shown in elongated housing 901. Air outlet 910 may include grill elements 912 for directing a flow of exhaust air exiting vertical air outlet 910.

Impeller assembly 930 is disposed within elongated housing 901. Impeller assembly 930 induces intake air to enter elongated housing 901 via air inlets 970. Impeller assembly 930 accelerates the intake air creating an exhaust air flow which exits elongated housing 901 via air outlet 910. Also shown is control 950 used to control a function of impeller assembly 930.

Attachment mechanism 980 is connected to elongate housing 901 and is utilized to mount space saving fan 900 to a surface such as, for example the edge of a desk or a table. In the exemplary embodiment attachment mechanism 980 is shown as a spring loaded clip having portion “A” 982 and portion “B” 984. Portion “B” 984 is connected to housing 901 via stem 986. Portion “A” 982 moves relative to portion “B” creating space 988 between ends 982b and 984b of portion “A” 982 and portion “B” 984 respectively. A spring, (not shown) is used to force ends 982b and 984b together. When the edge of a surface is placed within space 988 the spring holds attachment mechanism 980 and elongated housing 901 in location relative to the support surface. Although attachment mechanism 980 is shown as a spring loaded clip the invention is not so limited. It is contemplated that various attachment mechanisms could be used, such as for example, magnets, adhesives, threaded clamps and the like.

As shown, housing 901 is oriented horizontally, however the invention is not so limited. It is contemplated that housing 901 could connect to attachment mechanism 980 so as to be oriented vertically. It is also contemplated that attachment mechanism 980 may be detachably coupled to housing 901 such that the removal of attachment mechanism 980 from housing 901 would allow space saving fan 900 to engage a mounting surface with surface 904 or surface 906 of housing 901.

It is also contemplated that elongate housing 901 may rotate relative to attachment mechanism 980. For example, elongate housing 901 may rotate around a vertical axis of stem 986 and/or around a horizontal axis of rotation located proximate the interface of stem 986 and elongate housing 901. In this manner, the ability to direct a flow of exhaust exiting elongate housing 901 is enhanced.

As can be appreciated, the use of attachment mechanism 980 in conjunction with the ability to detachably couple attachment mechanism 980 to housing 901 greatly increases the flexibility of use for space saving fan 900.

As described, the space saving fan 100 uses cross-flow air impeller 132 within housing 101. The use of cross-flow air impeller 132 within a housing reduces the detectable movement of impeller. 132 thus reducing the distraction associated with the rotation of an axial fan blade of a conventional fan. Housing 101 of space saving fan 100 has a minimized planar foot print area, thus enhancing its space saving characteristics. Cross flow impeller 132 in conjunction with motor 134 produces an exhaust air stream with sufficient volume and velocity to effectively impinge and cool the user. Cross-flow air impeller 132 is so designed so as to conform to the vertically elongated aspect ratio of space saving fan 100.

Space saving fan 100 also has the ability to allow a user to more precisely direct exhaust air stream 342 exiting through vertical air outlet 110, when compared to a conventional fan using an axial fan blade. The use of rotation, oscillation and louvers contribute to optimizing the directional capabilities of the exhaust air flow.

Due to it's structure, shape and compact size, space saving fan 100 uses a shipping package that promotes efficient transportation. Greater quantities of space saving fan 100 can be place in a shipping container, (truck), yielding a cost advantage for the manufacturer and user.

Although the invention has been described with reference to exemplary embodiments, it is not limited thereto. Rather, the appended claims should be construed to include other variants and embodiments of the invention, which may be made by those skilled in the art without departing from the true spirit and scope of the present invention.

What is claimed:

1. A portable free standing space saving fan comprising:
a vertically oriented housing;
an air inlet;
a substantially vertically oriented air outlet having a flow through area;
an impeller assembly disposed within said vertically oriented housing comprising;
a motor;
a cross-flow air impeller connected to and rotated by said motor, said cross-flow impeller comprising;
an overall axial length of said cross-flow air impeller;
a pre-determined diameter of said cross-flow air impeller;
a plurality of blades substantially equally spaced and located proximate a peripheral circumference of said pre-determined diameter;
a substantially vertically oriented axis of rotation of said cross-flow air impeller;
an exhaust port having a substantially unimpeded flow through area;
an intake air flow drawn into said vertically oriented housing through said air inlet by a rotation of said cross-flow air impeller; and
an exhaust air flow generated by said rotation of said cross-flow air impeller exiting from said vertically oriented housing through said substantially vertically oriented air outlet;
wherein said pre-determined diameter of said cross-flow air impeller is less than about 2.5 inches and said rotational speed of said cross-flow air impeller is greater than about 1850 RPM.

2. The portable free standing space saving fan of claim 1, wherein said overall axial length of said cross-flow air impeller is greater than about 2 times said pre-determined diameter of said cross-flow air impeller.

3. The portable free standing space saving fan of claim 1, wherein said motor produces a maximum torque of less than about 1.0 inch ounce.

4. The portable free standing space saving fan of claim 1, wherein said motor is a two pole motor.

5. The portable free standing space saving fan of claim 4, wherein said motor further comprises at least two separate and direct wound stator coils.

6. The portable free standing space saving fan of claim 4, further comprising a shield to minimize the size of an electro magnetic field generated by said motor.

7. The portable free standing space saving fan of claim 1, wherein said motor is a Direct Current (D.C.) electric motor.

8. The portable free standing space saving fan of claim 7, further comprising batteries to power said motor.

9. The portable free standing space saving fan of claim 1, further comprising a control for controlling rotational speeds of said motor, wherein said motor is wound as a single speed motor and a differentiation of said rotational speeds is accomplished through said control.

10. The portable free standing space saving fan of claim 1, further comprising:
an overall vertical dimension of said portable free standing fan measured substantially orthogonal to a support surface to a highest vertical extent of said space saving fan above said support surface; and
a hypothetical cylinder having a diameter capable of encompassing the extents of said vertically oriented housing, the axis of said hypothetical cylinder being oriented substantially parallel to said axis of rotation of said cross flow impeller;
wherein said diameter of said hypothetical cylinder is less than about 5 inches.

11. The portable free standing space saving fan of claim 10, wherein said diameter of said hypothetical cylinder is between about 1.5 inches and about 4.5 inches.

12. The portable free standing space saving fan of claim 10, wherein said overall vertical dimension is at least about 2 times greater than said diameter of said hypothetical cylinder.

13. The portable free standing space saving fan of claim 10, further comprising a shipping package defined by a package height, a package width, and a package depth, wherein said package height is less than 115% of said overall vertical dimension of said portable free standing fan and said package width and depth are both less than less than 115% of said diameter of said hypothetical cylinder.

14. The portable free standing space saving fan of claim 1, wherein said exhaust air flow has a velocity of at least about 500 feet per minute when measured proximate said substantially vertically oriented air outlet.

15. The portable free standing space saving fan of claim 1, wherein said exhaust air flow has an air volume of at least about 20 cubic feet per minute.

16. The portable free standing space saving fan of claim 1, wherein a rotational speed of said cross-flow air impeller is between about 2000 and 3500 RPM;
wherein said pre-determined diameter of said cross flow impeller is less than or equal to about 2.5 inches;
wherein said plurality of blades further comprises:
a quantity of about 18 to 22 metal blades; and
a material thickness of said blades between about 0.01 inches and 0.02 inches.

17. The portable free standing space saving fan of claim 16, wherein said exhaust air flow has a velocity of at least about 1000 feet per minute and an air volume of at least about 35 cubic feet per minute.

18. The portable free standing space saving fan of claim 1, wherein said impeller assembly further comprises:
an air guide having a concave form when referenced from said axis of rotation of said cross-flow air impeller; and
an air cut-off having a convex form when referenced from said axis of rotation of said cross-flow air impeller.

19. The portable free standing space saving fan of claim 18, wherein said air guide further comprises:
a rear portion located proximate an intake side of said air impeller, wherein said rear portion guides intake air into said blades;
a center portion in close proximity to said air impeller, wherein said center portion of said air guide forms a boundary that separates said intake side of said air impeller from an exhaust side of said air impeller;
a forward portion located proximate said exhaust side of said air impeller, wherein said forward portion guides exhaust air exiting said blades towards said air outlet; and
a distal end of said forward portion of said air guide in contact with said second side of said air outlet.

20. The portable free standing space saving fan of claim 18, wherein said air cut-off further comprises:
a first portion in contact with a first of said air outlet, wherein said first portion extends toward a center axis of rotation of said air impeller and guides exhaust air exiting said blades towards said air outlet; and
a portion in close proximity to said air impeller, wherein said portion in close proximity to said air impeller forms a boundary that separates said intake side of said air impeller from an exhaust side of said air impeller.

21. The portable free standing space saving fan of claim 1, further comprising a base contacting said support surface and rotatably connected to said vertically oriented housing wherein said vertically oriented housing is rotatable with respect to said base about a substantially vertical axis of rotation.

22. The portable free standing space saving fan of claim 21 wherein said substantially vertical axis of a rotation of said vertically oriented housing is substantially co-linear with said substantially vertically oriented axis of rotation of said cross-flow air impeller.

23. The portable free standing space saving fan of claim 1, wherein said plurality of blades of said cross-flow air impeller are fabricated of metal.

24. The portable free standing space saving fan of claim 1, wherein said plurality of blades of said cross-flow air impeller are fabricated of a polymer.

25. The portable free standing space saving fan of claim 1, wherein said exhaust port of said cross-flow air impeller is in substantially unimpeded fluid communication with said vertically oriented air outlet.

26. The portable free standing space saving fan of claim 1, wherein said flow through area of said vertically oriented air outlet is greater than about 50% of said substantially unimpeded flow through area of said exhaust port of said impeller assembly.

27. The portable free standing space saving fan of claim 1, wherein said vertically oriented air outlet has an aspect ratio of at least about 4 to 1 defined by a vertical length of said air outlet being greater than a horizontal width of said air outlet.

28. The portable free standing space saving fan of claim 27, wherein said horizontal width of said air outlet is less than about 1.5 inches.

29. The portable free standing space saving fan of claims 1, further comprising a weather proof construction comprising one or more of: a rain sensor, water proof materials, sealed housing, sealed motors, and/or sealed switches.

30. The portable free standing space saving fan of claim 1, further comprising: at least one of a clock, a thermometer, a light source, and/or a storage compartment.

31. The portable free standing space saving fan of claim 1, wherein said air outlet is laterally off-set of a centerline of said housing in a direction to be substantially in alignment with a discharge quadrant of said air impeller.

32. The portable free standing space saving fan of claim 31,
wherein a first side of said air outlet is substantially aligned with an axis of rotation of said air impeller; and
wherein a second side of said air outlet is off-set laterally from said first side of said air outlet in a direction corresponding to an exhaust side of said air impeller.

33. The portable free standing space saving fan of claim 31, further comprising:
an air cut-off, wherein a first side of said air cut-off is substantially aligned with said first side of said air outlet; and
an air guide, wherein a front portion of said air guide is substantially aligned with said second side of said air outlet.

34. A portable space saving fan and attachment mechanism combination comprising:
a space saving fan comprising:
an elongate housing
at least one air inlet;
an elongate air outlet having a flow through area;
an impeller assembly disposed within said elongate housing comprising;
a motor;
a cross-flow air impeller connected to and rotated by said motor, said cross flow impeller comprising;
a pre-determined diameter of said cross-flow air impeller being less than about 2.5 inches;
an overall axial length of said cross-flow air impeller;
a plurality of blades substantially equally spaced and located proximate a peripheral circumference of said pre-determined diameter;
an axis of rotation of said cross-flow air impeller;
an aspect ratio of said axial length to said pre-determined diameter of said cross-flow air impeller greater than about 2 to 1;
an exhaust port having a substantially unimpeded flow through area;
an intake air flow drawn into said elongate housing through said at least one air inlet by a rotation of said cross-flow air impeller;
an exhaust air flow generated by said rotation of said cross-flow air impeller exiting from said elongate housing through said elongate air outlet.
a hypothetical cylinder having a diameter of less than about 5 inches, said hypothetical cylinder being capable of encompassing the extents of said elongate housing and the axis of said hypothetical cylinder being oriented substantially parallel to said axis of rotation of said cross flow impeller; and
an attachment mechanism connected to said elongate housing for attaching said space saving fan to a support surface.

35. The combination portable space saving fan and attachment mechanism of claim 34, wherein said attachment mechanism is detachably coupled to said elongate housing.

36. The combination portable space saving fan and attachment mechanism of claim 35, wherein said elongate housing absent said attachment mechanism can be placed operationally on a substantially flat support surface.

37. The combination portable space saving fan and attachment mechanism of claim 34, wherein said axis of rotation of said cross-flow air impeller is substantially parallel to said support surface.

38. The combination portable space saving fan and attachment mechanism of claim 34, wherein said axis of rotation of said cross-flow air impeller is substantially orthogonal to said support surface.

39. The combination portable space saving fan and attachment mechanism of claim 34, wherein said axis of rotation of said cross-flow air impeller is angularly adjustable relative to said support surface.

40. The combination portable space saving fan and attachment mechanism of claim 34, wherein said motor is a two pole motor.

41. The combination portable space saving fan and attachment mechanism of claim 40, wherein said motor further comprises at least two separate and direct wound stator coils.

42. The combination portable space saving fan and attachment mechanism of claim 34, further comprising a shield to impede the electro magnetic field generated by said motor.

43. The combination portable space saving fan and attachment mechanism of claim 34, wherein said exhaust air flow has a velocity of at least about 500 feet per minute when measured proximate said air outlet.

44. The combination portable space saving fan and attachment mechanism of claim 34, wherein said exhaust air flow has an air volume of at least about 20 cubic feet per minute.

45. The combination portable space saving fan and attachment mechanism of claim 34, wherein said motor is a Direct Current (D.C.) electric motor.

46. A portable space saving fan comprising:
an elongate housing
at least one air inlet;
an elongate air outlet having a flow through area;
an impeller assembly disposed within said elongate housing comprising;
a cross-flow air impeller comprising;
a pre-determined diameter of said cross-flow air impeller being less than about 2.5 inches;
an overall axial length of said cross-flow air impeller;
a plurality of blades substantially equally spaced and located proximate a peripheral circumference of said pre-determined diameter;
an axis of rotation of said cross-flow air impeller;
an aspect ratio of said axial length to said pre-determined diameter of said cross-flow air impeller greater than about 2 to 1;
an exhaust port having a substantially unimpeded flow through area;
a motor connected to and rotating said cross-flow air impeller at a rotational speed of greater than about 1850 RPM;
an intake air flow drawn into said elongate housing through said at least one air inlet;
an angle of intake defined by a vertex located proximate said axis of rotation of said cross flow impeller and by at least two intake air boundaries of said intake air as it enters said elongate housing;
an exhaust air flow exiting from said elongate housing through said elongate air outlet; and
a centerline of said exhaust air flow located at least about 45 degrees from one of said at least two boundaries of said angle of intake;
wherein said angle of intake is greater than about 60 degrees; and
wherein said exhaust air flow exiting from said elongate housing is located in a quadrant substantially diagonal from a radial center line of said angle of intake.

47. The portable space saving fan of claim 46, further comprising a hypothetical cylinder, wherein said hypothetical cylinder comprises:
a diameter of less than about 5 inches and capable of encompassing the extents of said elongate housing;
a longitudinal axis, wherein said longitudinal axis of said hypothetical cylinder is oriented substantially parallel to said axis of rotation of said cross flow impeller.

48. The portable space saving fan of claim 46, wherein said exhaust air flow has a velocity of at least about 500 feet per minute when measured proximate said elongate air outlet.

49. The portable space saving fan of claim 46, wherein said exhaust air flow has an air volume of at least about 20 cubic feet per minute.

50. The portable free standing space saving fan of claim 46, wherein said exhaust air flow has a velocity of at least about 1000 feet per minute and an air volume of at least about 35 cubic feet per minute.

51. The portable space saving fan of claim 46, further comprising a base contacting a support surface and rotatably connected to said elongate housing, wherein said elongate housing is rotatable about a substantially vertical axis of rotation.

52. The portable space saving fan of claim 46, further comprising an attachment mechanism connected to said elongate housing, wherein said attachment mechanism attaches said space saving fan to a support surface.

53. The portable space saving fan of claim 52, wherein said attachment mechanism is detachably coupled to said elongate housing.

54. The portable space saving fan of claim 46, wherein said impeller assembly further comprises:
an air guide having a concave form when referenced from said axis of rotation of said cross-flow air impeller; and
an air cut-off having a convex form when referenced from said axis of rotation of said cross-flow air impeller.

55. The portable space saving fan of claim 54, further comprising:
an intake side defined between said air cut-off and said air guide traveling is a direction of rotation of said air impeller, wherein said intake side extends over about two quadrants of a periphery of an outer circumference of said air impeller; and
an exhaust side defined between said air guide and said air cut-off traveling is a direction of rotation of said air impeller ,wherein said exhaust side extends over about one quadrant of said periphery of said outer circumference of said air impeller.

56. The portable space saving fan of claim 46, wherein said plurality of blades of said cross-flow air impeller are fabricated of metal.
